(19) United States
(12) Patent Application Publication
(10) Pub. No.: US 2005/0087044 A1
(43) Pub. Date: Apr. 28, 2005

(54) Finger Wrench

(76) Inventor: Larry Joseph Risolio, Galena, OH (US)

Correspondence Address: JEFFREY FURR, 253 N. MAIN STREET, JOHNSTOWN, OH, 43031, US

(21) Appl. No.: 10/904,591

(22) Filed: Nov. 17, 2004

Related U.S. Application Data
(63) Continuation-in-part of application No. 10/248,534, filed on Jan. 27, 2003, now Pat. No. 6,834,570.

(51) Int. Cl. B25B 23/16

(52) U.S. Cl. 81/177.3

(57) ABSTRACT

A finger wrench that can be used to reach hard to reach locations. The wrench consists of a base with a retainer band. Said base having a nut holder fitting nuts of set sizes. Said nut holder having a nut retaining means such as a nub to hold the nut in place. The band attaches to the base and around the finger or a shaft.

### CROSS REFERENCE TO RELATED APPLICATIONS

The present Application is a Continuation of U.S. patent application Ser. No. 10/248534 entitled “Finger Wrench”, filed Jan. 27, 2003.

### BACKGROUND OF INVENTION

This invention relates generally to wrench type tools and more particularly those that can be used by a finger or shaft.

1. Background

Anyone who has ever used a wrench can understand the frustration of trying to loosen and remove a bolt or nut that is in a difficult to reach location, particularly if it is an enclosed and out of sight location. These are locations such as behind on a starter, alternator, stereos, heater core, heater ducts, power supplies, refrigerator units and shocks.

Sometimes even using a long lever arm to turn the wrench is not enough. Very often the bolt or nut is located in a location where attempting to start or loosen it makes the task more difficult, even with other types of gripping tools.

Wrenches having a head with a square or rectangular ratcheting shaft are well known and are commonly used in various home, shop and office environments. Shafts for such wrenches are typically available in various sizes of the English and metric measurement systems. Interchangeable sockets can be mounted to the shaft for loosening or tightening bolts and other threaded fasteners. The sockets are often designed in sets so that multiple sockets have the same sized square shaft opening with hexagonal openings for receiving bolts heads and nuts that vary in size, such as in increments of one-sixteenth of an inch.

2. Description of Prior Art

There are adjustable sockets. Typical of these is U.S. Pat. No. 1,471,451 issued to Alfred A. Crimp on Oct. 23, 1923.

Another patent was issued to George J. C. Lammers et al. on Feb. 22, 1927 as U.S. Pat. No. 1,618,715. Yet another U.S. Pat. No. 1,688,819 was issued to John Leck on Oct. 23, 1928 and still yet another was issued to John Greiner on Feb. 7, 1933 as U.S. Pat. No. 1,896,949.

Another patent was issued to Andrew Pearson on Apr. 16, 1935 as U.S. Pat. No. 1,997,948. Yet another U.S. Pat. No. 2,711,112 was issued to Adrein E. Durand on Jun. 21, 1955. Another was issued to Jesse P. Rogers on Apr. 7, 1964 as U.S. Pat. No. 3,127,797 and still another was issued on Apr. 7, 1964 to Michael J. Gol as U.S. Pat. No. 3,127,798. A patent was issued on Jan. 17, 1967 to Ben H. Lynn as U.S. Pat. No. 3,298,261 and on Jul. 16, 1985 U.S. Pat. No. 4,528,875 was issued to Andrew C. S. Hurst et al.

Another patent was issued to William S. Mathers on Nov. 17, 1992 as U.S. Pat. No. 5,163,344. Yet another U.S. Pat. No. 5,829,328 was issued to Shyong-Chwan Chen on Nov. 3, 1998.

While these wrench devices may be suitable for the purposes for which they were designed, they would not be as suitable for the purposes of the present invention, as hereinafter described. In particular, no prior art wrenches can be used in tight locations using a single finger or long shaft holding the nut or bolt head to be wrenched.

### SUMMARY OF INVENTION

The present invention relates to a finger wrench that can be used to reach hard to reach locations.

It is the object of the present invention to provide a wrench that allows a user to reach hard to reach locations.

It is an addition object of the present invention to provide a wrench that allows a user for use in locations where you can not see where all a user can do is touch and feel the location with a finger.

It is another object of the present invention to provide a wrench that holds the nut while it is being moved to its proper location.

Is another object of the present invention to provide a quick start for nuts.

The wrench consists of a base with a retainer band, with said base containing a nutholder the fits a set set of sizes, said wrench has a nut retaining means, such as a nub, to hold the nut in place. The band attaches to the base and around the finger or a shaft.

### BRIEF DESCRIPTION OF DRAWINGS

Without restricting the full scope of this invention, the preferred form of this invention is illustrated in the following drawings:

FIG. 1 shows the device;

FIG. 2 is a top view of the device;

FIG. 3 is a bottom view of the device;

FIG. 4 is a back view of the device;

FIG. 5 is a front view of the device;

FIG. 6 shows the main components of the device;

FIG. 7 shows a nut being held by the device;

FIG. 8 shows the nub with a nut;

FIG. 9 shows the device being used with magnets;

FIG. 10 shows the device on a finger;

FIG. 11 shows the device with a socket holder;

FIGS. 12A-D shows alternative methods for attaching the band to said device;

FIG. 13 shows the band with a die;

FIG. 14 shows the band attached to the base;

FIG. 15 shows a latching method to attach the band to the base; and

FIG. 16 shows the band running through slots on the base.

### DETAILED DESCRIPTION

The following description of a finger wrench is demonstrative in nature and is not intended to limit the scope of the invention or its application of uses.

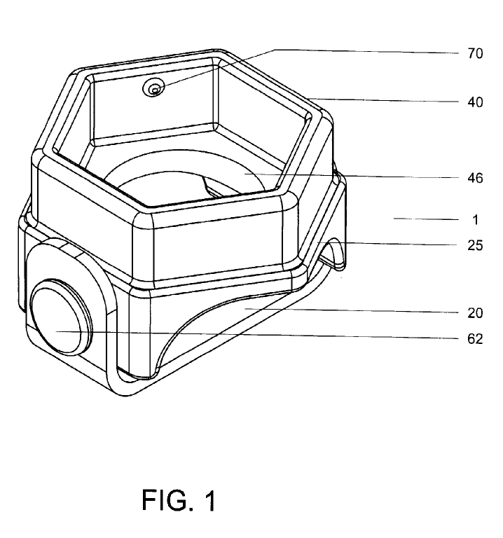

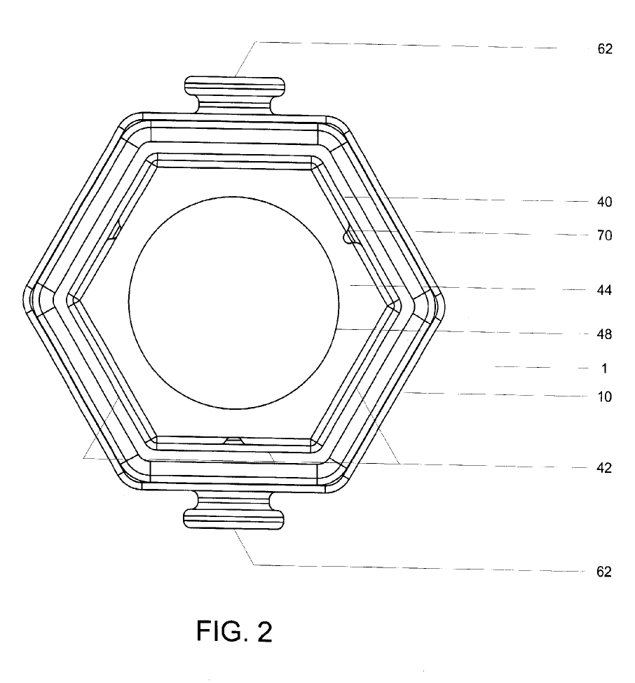

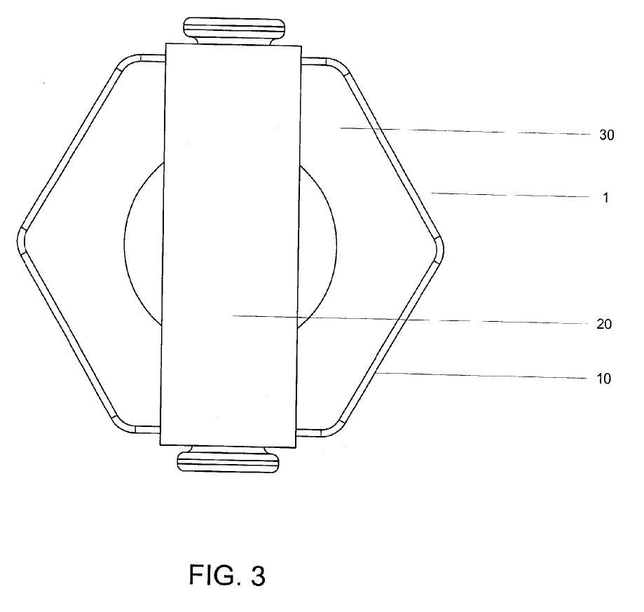

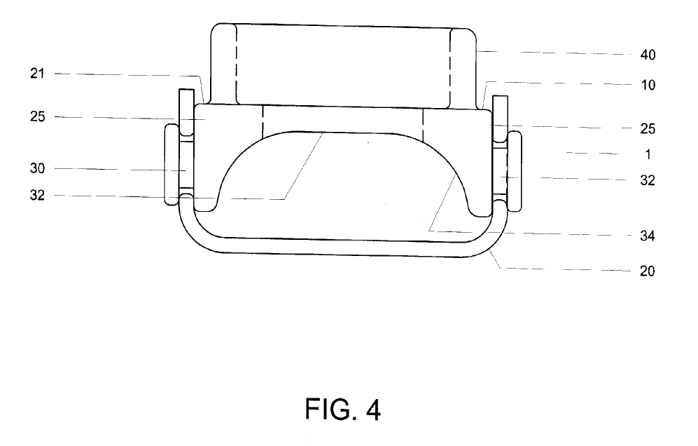

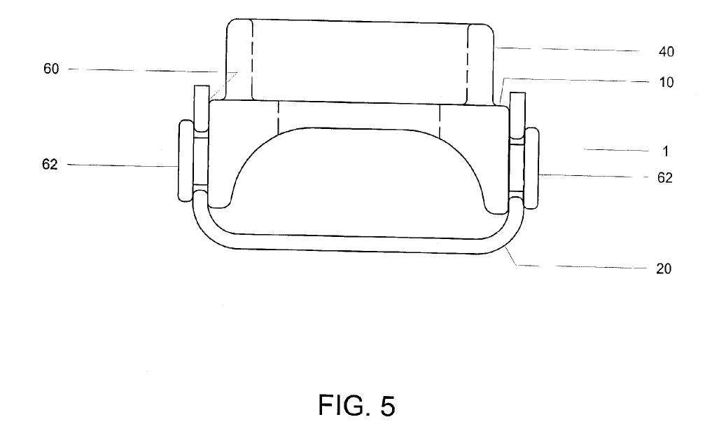

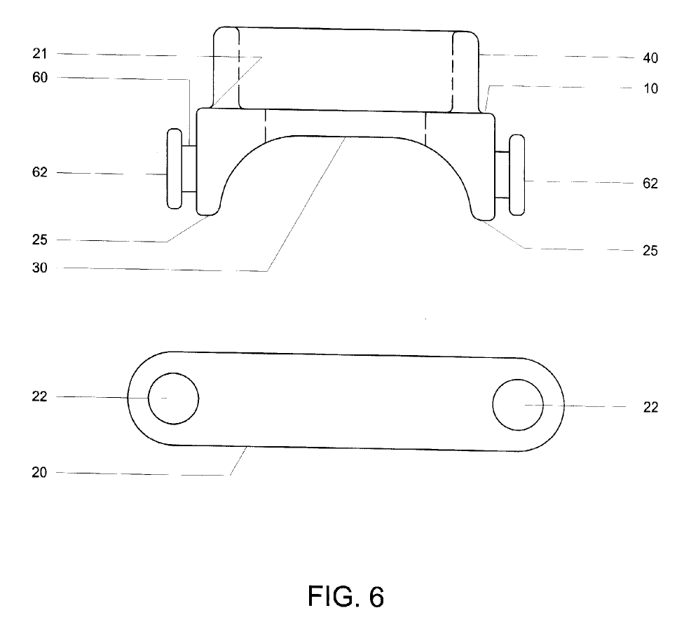

FIGS. 1 through 6 display the finger wrench 1. The finger wrench 1 comprises a base 10 and a retainer band 20.

The base 10 has a top end 22, side 25 and a bottom end 30. The top end 22 has a flat surface. The bottom end 30 is arced to fix the contours of a person's finger, thumb or a shaft.

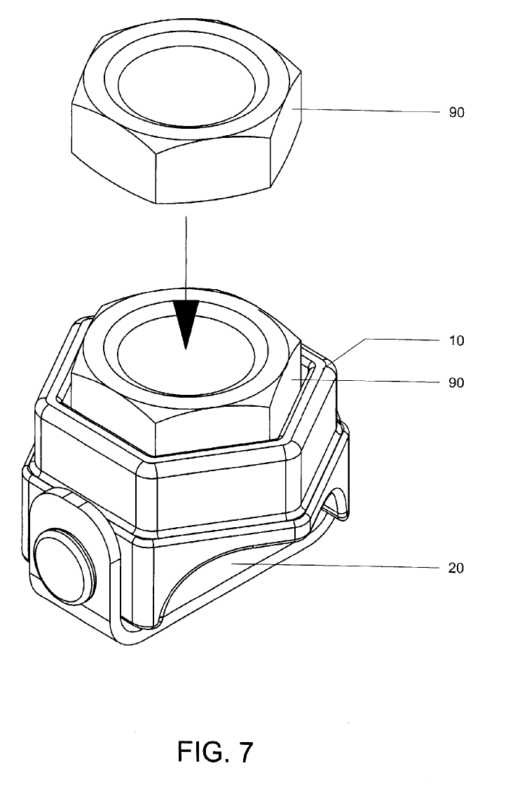

The base 10 has a nut holder 40 on the top end 22. In the preferred embodiment, the nut holder 40 is comprised of six walls 42 of equal lengths. These lengths would match one of the standard nut sizes. These sizes include but are not limited to 4 mm, 4.5 mm, 5 mm, 6 mm, 7 mm, 8 mm, 9 mm, 10 mm, 11 mm, 12 mm, 13 mm, 14 mm, 15 mm, 3/16 inch, 7/32 inch, ¼ inch, 9/32 inch, 5/16 inch, 11/32 inch, ⅜ inch, 7/16 inch, ½ inch and 9/16. The current invention can use other sizes including non-standard sizes as well. The height of the walls 42 in the preferred embodiment is ¼ of an inch. The walls 42 extend from the base 10 with the top of the nut holder 40 being perpendicular to the walls 42 and being open forming the nut holder opening 44 so the nut 90 can be placed in the nut holder 40 as shown in FIG. 7. The base 10 has a nut holder floor 46 which is at the bottom of the nut holder 40 opposite the nut holder opening 44. The nut holder floor 46 is perpendicular to the walls 42 and is a flat surface. The nut holder floor 46 stops the nut 90 from going through the nut holder 40 allowing the nut holder 40 to hold the nut 90 in place. In the preferred embodiment, the nut holder floor 46 has a circular opening 48 through it and the base 10. This circular opening 48 is of a size that the nut 90 will not fall through but large enough so that a bolt shaft for the nut size of the wrench 1 can fit through it.

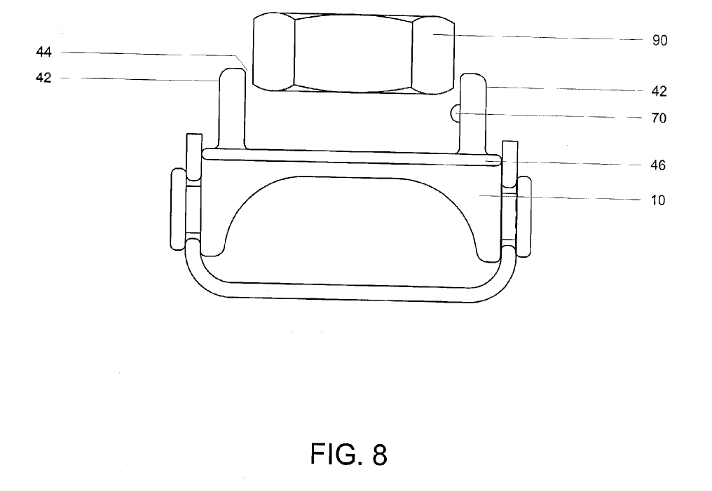

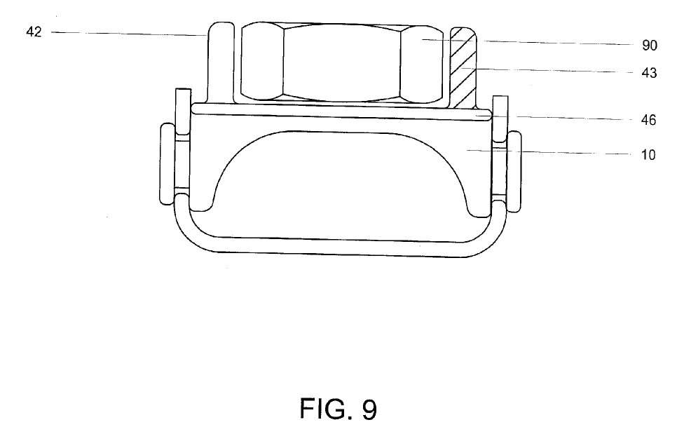

The nut holder 40 will have a nut securing means 70 in the preferred embodiment. The nut securing means 70 is a means to secure the nut 90 so that the nut 90 will stay in the nut holder 40 even if the nut holder opening 44 is turned towards the ground. In the preferred embodiment a compression/tension means is used. A plastic or polyurethane nub 70 is added to one or more of the walls 42 of the nut holder 40. When the nut 90 is placed into the nut holder 40 the nub 70 will make contact with one of the sides of the nut 90 and will be compressed. This compression will hold the nut 90 in the nut holder 40 through the fraction between the compressed nub 70 and the side wall of the nut 90 as show in FIG. 8. Other forms of securing the nut 90 can be used, such as nubs where the wall 42 meet, springs from the walls 42 or as shown in FIG. 9 one or more of the walls 42 could be magnetized 43.

In the preferred embodiment, the wrench will have two latches 60 on opposite sides of the base 10. These sides are the one that match the contours of the bottom 30 to the latches 60 are on the long sides 32 of the contour 34. These latches 60 extend out of the base 10 perpendicular to the walls and parallel to the nut holder floor 46. The latches end in a button 62. The button 62 is used to secure the retainer band 20.

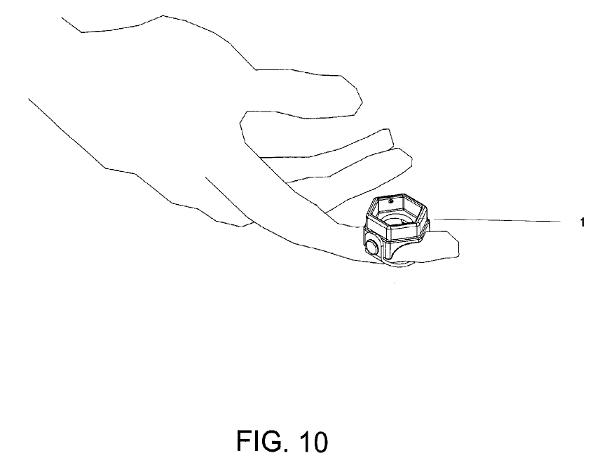

The retainer band 20 is an elongated shape and has two band openings 22 at each of the elongated ends. The retainer band 20 in the preferred embodiment is made of an elastic material such as rubber or elastic. The two band openings 22 fit over the buttons 62 of the base 1 thereby forming a loop. A user's finger or a shaft fits into the loop. The elastic material will hold the wrench 1 securely against the finger or shaft as shown in FIG. 10.

Preferably the base of the finger wrench is fabricated of quality stainless steel used in making fine tools. The finger wrench can also be made of a durable hard plastic.

In operation, the nut 90 is placed within the finger wrench 1 and is held in place using the securing means 70. The finger wrench 1 with the nut 90 is placed where the nut 90 is needed to be screwed or tightened on to. The finger wrench 1 is used to hold the nut 90 in place while a bolt is turned. In another operation the finger wrench 1 is placed over a nut 90 while the connecting means or bolt and turned to tighten or loosen the nut 90 or bolt.

It is understood that the preceding description is given merely by way of illustration and not in limitation of the invention and that various modifications may be made thereto without departing from the spirit of the invention as claimed.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed.

### ALTERNATIVE EMBODIMENT

The device 1, in an alternative embodiment, is made of a one solid piece where the base 10 and the retainer band are molded together much like a ring. This can be made by injection molding out of a flexable material such as a soft plastic or rubber. This technique of forming the solid piece out of a flexable material is new to the art. The nut holder 40 can be made of a more durable material and attached to the flexable base 10.

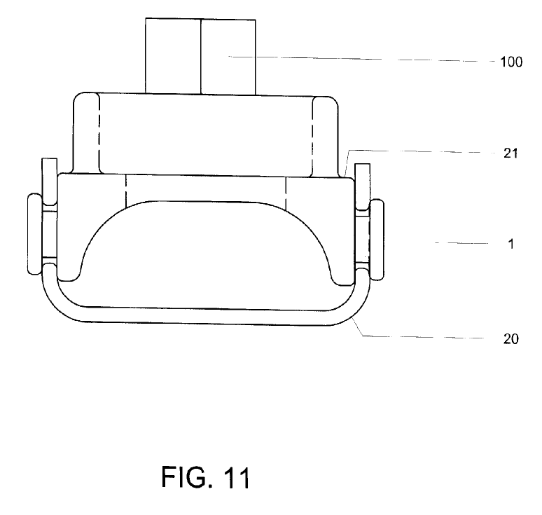

In an addition embodiment, the finger wrench has a socket holder 100 instead of a nut holder as shown in FIG. 11. This socket holder would be an industry standard socket holder and would work with standard sockets of different sizes. The finger wrench can also be designed to work with an inverted torx wrench.

In other embodiments, the retainer band 20 is an elongated shape and has two band openings 22 at each of the elongated ends. The retainer band 20 in the preferred embodiment is made of an elastic material such as rubber or elastic. The two band openings 22 fit over the buttons 62 of the base 1 thereby forming a loop. A user's finger or a shaft fits into the loop. The elastic material will hold the wrench 1 securely against the finger or shaft. A flexable wire or other similar material can be used instead of the elastic material.

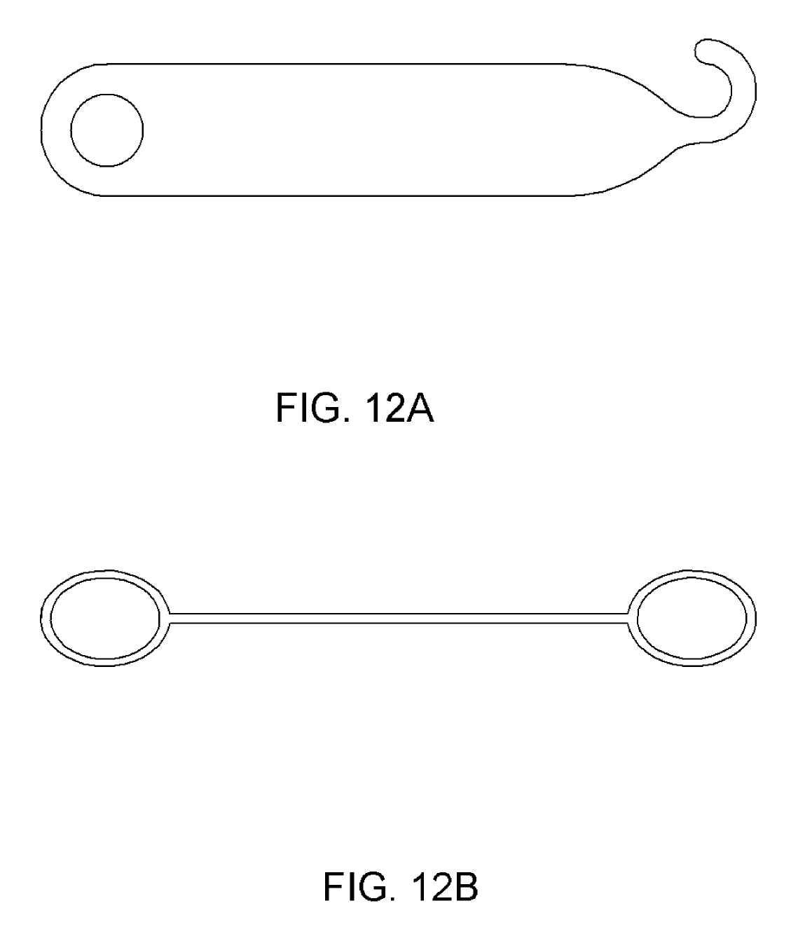

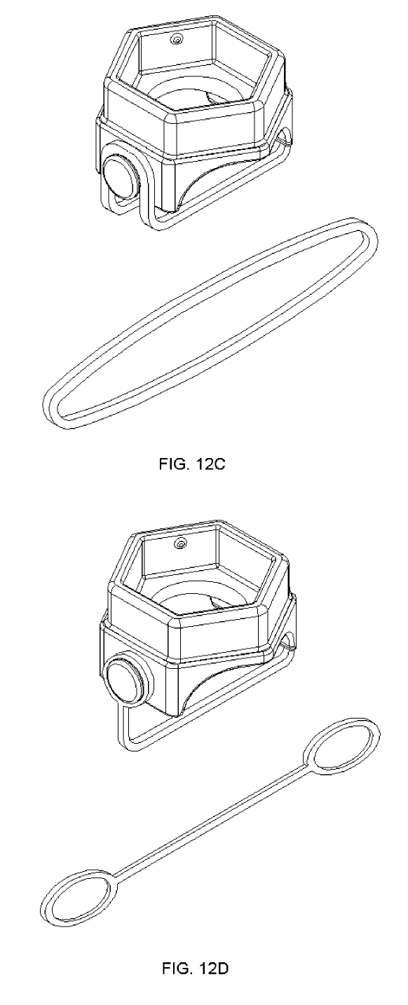

Other configurations can be used to attached the retainer band 20 to the base 10. As shown in FIG. 12a, one or both ends of the retainer band could be hooks which attach to buttons 62 or a similar hook connector means. As shown in FIG. 12b, a hook around strap can be used. As shown in FIG. 12c, a rubber band 52 can be used. The rubber band can be doubled up. As shown in FIG. 12d, a hookstar can be used to attach the retainer band 20 to the base 10. The retainer band 20 can be attached to said base 10 using a hook and latch means.

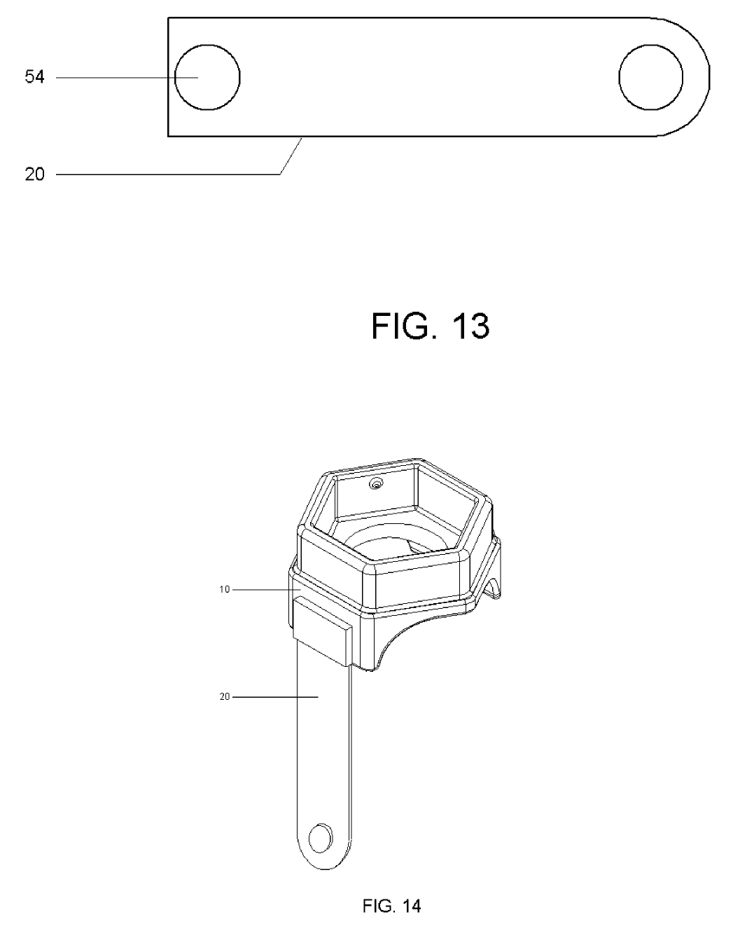

A hook around strap 52 can be used with the base 10. A hook around strap connects to a hooking means 53 which can be on the bottom of the base as shown in FIG. 13. The retainer band 20 can be connected to the base through the use of a die 54 at one or both ends. The retainer band 20 can have a die 54 on one end and a hook, loop, hookstrap or some other type of connecting means on the other end which is used to attached to the base through a connector means.

As shown in FIG. 14, one end of the retainer band 20 can be connected to the base 10 by either being injected molded as part of the base 10 or glued, welded or heat pressed so that it is attached to said base 10. The other non-attached end of the retainer band 20 can have a hook, loop, hookstrap or some other type of connecting means on the other end which is used to attached to the base through a connector means.

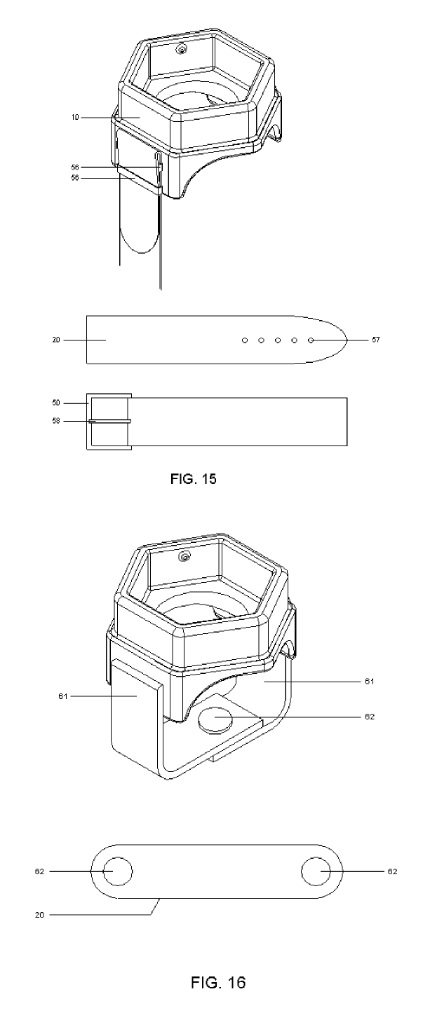

The retainer band 20 can also attached to said base 10 using a folding strap means. The fold strap means has the retainer band 20 folding around a latch 56 much like a belt or watch is using an adjustable strap. This is shown in FIG. 15. The retainer band 20 could also have a plurality of hole 57 will attach to a post 58 much like a belt does to allow for a simple adjustable strap.

The retainer band 20 can also fit through slots 61 in the base 10 and loop and connect to itself using a connecting means such as a button 62 and hole 63 as shown in FIG. 16.

Advantages The previously described version of the present invention has many advantages, including many elements missing in all prior art. It provides a wrench that can be used in difficult to reach and use areas.

Although many features, functions, and advantages of the present invention have been described in this specification, together with details of the structure of specific embodiments thereof, the description as a whole is illustrative only, and substitutions may be made in detail, especially in matters of shape, dimension and arrangement of elements within the principles of the invention to the full extent indicated by the broad, general meaning of the terms in which the claims are expressed. Therefore, the point and scope of the appended claims should not be limited to the description of the preferred versions contained herein.

1. A finger wrench comprising;
a base having a top surface, a bottom surface and two sidewalls; said bottom surface of said base being contoured to fit the shape of a finger; a nut holder formed on said top surface of said base defined with a plurality of sidewalls;
said nut holder having a nut securing means; and an elastic retainer band having an elongated shape defining two ends with each end including an opening;
wherein said elastic band is detachably connected to said base by a connecting means.

2. The wrench as in claim 1, wherein said elastic band and said base are one piece.

3. The wrench as in claim 2, wherein said elastic band and said base are madde out of a flexable material.

4. The wrench as in claim 1, wherein said elastic band is connected to said base by a plurality of hooks.

5. The wrench as in claim 1, wherein said elastic band is connected to said base by a plurality of dies.

6. The wrench as in claim 1, wherein said elastic band consists of a rubber band.

7. The wrench as in claim 1, wherein said elastic band is connected to said base by a hookstrap.

8. The wrench as in claim 1, wherein said elastic band is connected to said base by a plurality of hookstraps.

9. The wrench as in claim 1, wherein one end of said elastic band is physically bonded to said base with other end of said elastic band connected to said base through a connecting means.

10. The wrench as in claim 9, where said bonding means is heat bonding.

11. The wrench as in claim 9, where said bonding means is said bonding is injection molding.

12. The wrench as in claim 9, where said bonding means is a glue.

13. The wrench as in claim 9 where said connecting means is a button on said base and a hole is said elastic band.

14. The wrench as in claim 9 where said connecting means is a hookstrap.

15. The wrench as in claim 9 where said connecting means is a hook.

16. The wrench as in claim 9 where said connecting means is a hook and latch means.

17. The wrench as in claim 9 where said connecting means is a folding strap means.

18. The wrench as in claim 1, wherein said elastic band is connected to said base by a folding strap means.

19. The wrench as in claim 1, wherein said elastic band is connected to said base by a adjustable strap means.

20. The wrench as in claim 1, wherein said elastic band is connected to said base through a plurality of slots in the sides of said base.
